(19) United States
(12) Patent Application Publication
(10) Pub. No.: US 2007/0030118 A1
(43) Pub. Date: Feb. 8, 2007

(54) Electronic communications system

(76) Inventor: Juergen Nowottnick, Hamburg (DE)

Correspondence Address: PHILIPS INTELLECTUAL PROPERTY & STANDARDS, P.O. BOX 3001, BRIARCLIFF MANOR, NY, 10510, US

(21) Appl. No.: 10/557,645

(22) PCT Filed: May 13, 2004
(86) PCT No.: PCT/IB04/50675

§ 371 Date: Nov. 17, 2005

(30) Foreign Application Priority Data
May 20, 2003 (EP) 03101428.5

(51) Int. Cl. G05B 19/00

(52) U.S. Cl. 340/5.61; 340/5.64; 340/5.72; 307/10.5; 340/10.1; 70/456 R

(57) ABSTRACT

In order that an electronic communications system (100) equipped with: at least one base station (10) with at least one antenna unit (16), in particular taking the form of a coil, which base station (10) is disposed, in particular, on an object to be secured against unauthorized use and/or against unauthorized access, for example on a means of locomotion or on an access system, and at least one transponder station (40) with at least one antenna unit (44), in particular taking the form of a coil, which transponder station (40)—can, in particular, be carried by an authorized user and/or—is designed to exchange data signals (22, 24) with the base station (10) in the active state, wherein, by means of the data signals (22, 24)—the utilization and/or access entitlement can be determined and/or—the base station (10) can be controlled accordingly, can be further developed in such a way that a “relay attack” is at least significantly impeded, and, if possible, completely averted and prevented, it is proposed that the transponder station (40), in particular the antenna unit (44) of the transponder station (40), is screened, in the passive state, from electrical fields and/or from magnetic fields and/or from electromagnetic fields, by means of at least one screening unit (50).

The present invention relates generally to the technical field of security systems, including, in particular, electronic immobilizer systems, as used in, for example, the field of means of locomotion, in particular in the field of motor vehicles.

In particular, the present invention relates to an electronic communications system as claimed in the preamble of claim 1.

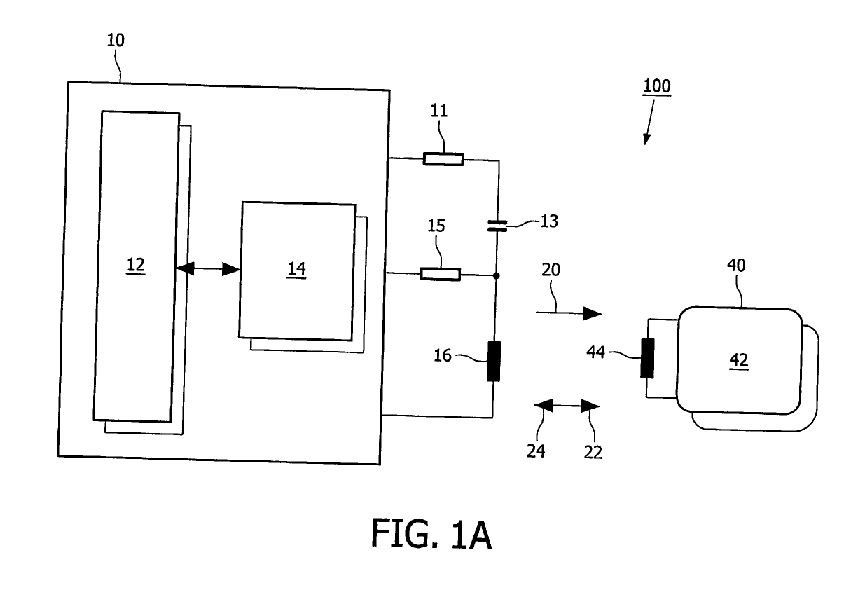

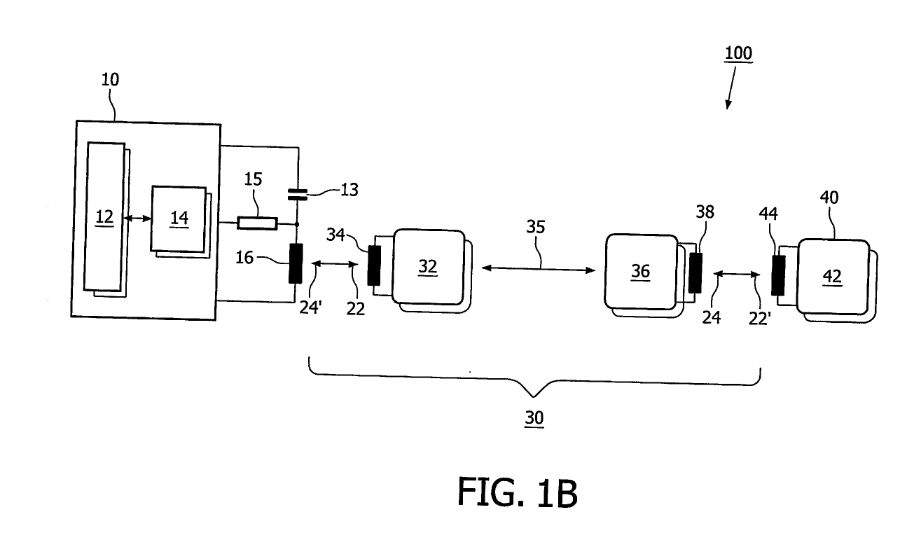

In order to realize electronic communications systems of the kind mentioned above, which are equipped inter alia with a conventional passive transponder system, various configurations are conventionally in use. One possible configuration for realizing a security system of the kind mentioned above is shown in FIG. 1A of the drawings with reference to the example of an electronic immobilizer system for a motor vehicle:

A base station 10 with an associated antenna unit 16, taking the form of a coil, firstly supplies the transponder station 40 inductively with power 20, i.e. the transponder station 40 is supplied via an inductive field; secondly, a communication sequence for authentication purposes takes place between the base station 10 and the transponder station 40:

In detail, there exist, as signal transmission connections between the base station 10 and the transponder station 40, a so-called up-link frame 22, which takes the form of, for example, at least one LF (Low Frequency) channel with inductive coupling and is transmitted via the signals from the base station 10 to the transponder station 40, and a so-called down-link frame 24, which takes the form of, for example, at least one LF channel and is transmitted via the signals from the transponder station 40 to the base station 10.

Following actuation of, for example, the ignition key of the motor vehicle, the base station 10 associated functionally and spatially with the motor vehicle starts to generate a signal known as a “challenge”, which is transmitted via the up-link frame 22 to the transponder station 40. Subsequently, using a cryptographic algorithm and a secret code, an electronic circuit configuration 42, preferably equipped with at least one microprocessor, in the transponder station 40 calculates from the challenge a signal train known as a “response”. This response signal is then transmitted from the transponder station 40 via the down-link frame 24 to the base station 10.

The base station 10 then compares the response using an identical crypto-algorithm and an identical secret code; if identity is established, the base station 10 causes the engine of the vehicle to start, i.e. only if the authentication recognizes the transponder station 40 as valid, generally using cryptographic methods, will the engine of the motor vehicle be started in the embodiment example described.

If this circuit configuration is operated in the form shown in FIG. 1A without any further technical supplementation, the risk exists that an external attacker who, without authorization, attempts to start the vehicle's engine can carry out a “relay attack”, as described below, with relatively little technical intervention.

FIG. 1B shows, schematically, an arrangement for carrying out a relay attack of this kind. To this end, an “attacker's tool” in the form of an additional transmission path 30, equipped with a first relay 32 in the form of an emulator for the transponder station, a second relay 36 in the form of an emulator for the base station and a message connection 35 between the first relay 32 and the second relay 36, is introduced into the configuration as shown in FIG. 1A.

In this context, the message connection 35 between the first relay 32 and the second relay 36 may take the form of at least one bi-directional transmission channel of any kind, which enables a distance of any kind between the first relay 32 and the second relay 36.

For inductive coupling with the antenna unit 16 of the base station 10, the first relay 32 in the form of the transponder station emulator is equipped with an associated antenna unit 34, designed in the form of a coil; by analogy with this, the second relay 36 in the form of the base station emulator is equipped, for inductive coupling with a coil-shaped antenna unit 44 of the transponder unit 40, with an associated antenna unit 38, designed in the form of a coil.

An attacker is now located right next to the motor vehicle with the first relay 32. The second attacker moves with the second relay 36 sufficiently close to the valid transponder station 40. The base station 10 of the motor vehicle, initiated by, for example, the bridging of a contact at the vehicle's ignition lock, sends its challenge to the first relay 32 by means of the original, i.e. not the emulated, up-link frame 22.

The challenge is forwarded from this first relay 32 via the above-mentioned message connection 35 to the second relay 36. The second relay 36 emulates the up-link 22′ and thus passes the challenge on to the valid transponder station 40 by means of the coil-shaped antenna unit 38. Following calculation of the response in the valid transponder station 40, this transponder station 40 responds to the second relay 36 by passing on this response by means of the original, i.e. not the emulated, down-link frame 24.

From this second relay 36, the response is forwarded to the first relay 32 via the above-mentioned message connection 35. The first relay 32 emulates the down-link 24′ and thus passes the response on to the valid base station 10 in the motor vehicle by means of the coil-shaped antenna unit 34.

Since the response has been generated by the authentic transponder station 40 on the basis of the authentic challenge of the base station 10 by means of the correct crypto-algorithm and the correct code, the response is recognized as valid and the engine is started despite the fact that this is against the wishes of the authorized legal user.

In view of the fact that nowadays it is precisely in, for example, the automotive or access fields that more stringent requirements are being placed on certain components as regards their function and security, the configuration shown in FIGS. 1A and 1B appears to be no longer adequately secure.

Accordingly, some proposals have been put forward in the past for detecting and averting relay attacks of this kind; for example, consideration has been given to determining the time between the challenge and the response in order that any additional time delay resulting from the delays of the relay electronics and from the additional signal propagation time between the relay stations can be detected in this manner (method of propagation time measurement).

However, it is virtually impossible to detect a relay attack by the method of propagation time measurement in a conventional transponder system with a carrier frequency of 125 kHz because the high accuracy requirements relating to time measurement cannot be fulfilled in practice, the main reasons being tolerances of the filters used and temperature problems.

Against the background of the above-described disadvantages and shortcomings, and acknowledging the outlined prior art, it is an object of the present invention to develop an electronic communications system of the type specified above in such a way that a relay attack is at least significantly impeded, and, if possible, completely averted and prevented.

This object is achieved by an electronic communications system with the features as claimed in claim 1. Advantageous embodiments and expedient further embodiments of the present invention are identified in the dependent claims.

The doctrine of the present invention rests on making an undesired operation of the transponder station impossible, by means of at least one screening unit, which is assignable to the transponder antenna in particular, with metallic materials or ferrites, for example.

The basic idea of the present invention thus consists in the screening of the transponder station from electrical fields, from magnetic fields or from electromagnetic fields at all times when the transponder station is not intended to perform authentication, identification and/or control functions, i.e. when the transponder is in the passive state (by contrast, the transponder station is in the active state when it is intended to perform authentication, identification and/or control functions).

With respect to the present invention, a person skilled in the field of communications electronics, for instance an electrical engineer with extensive knowledge in the field of security systems, will particularly appreciate the fact that relay attacks on transponder systems can be prevented by means of the described screening technology. Not least this latter technical aspect indicates—by comparison with systems known from the prior art—the enormous gain in active as well as passive security that the present invention provides.

A further advantage that should be noted with the present invention is that a practical realization is possible with simple mechanical means, which are often already available in a similar form for design reasons, and simply require modification. Accordingly, cost-effective realization options make the present method extremely interesting for use in mass production, since many mechanical variants enabling an automatic or manual screening of the transponder are conceivable.

For example, a rotary motion and/or a translatory motion of the screening unit relative to the transponder are possible. Irrespective of, or in conjunction with this, various materials such as metals, ferrites etc. are possible for screening purposes. Furthermore, it is applicable to passive, i.e. not battery-operated, transponders, or to active, i.e. battery-operated transponders, in a manner significant for the invention.

In accordance with a preferred embodiment of the present invention, the screening unit may be realized in a manner such that it becomes active automatically when the key is withdrawn from the vehicle lock. In this case, a spring can move a metallic housing over the transponder station as a magnetic screening.

The present invention, which also extends to both at least one base station of the type described above and at least one transponder station of the type described above, may be used in an advantageous manner in transponder systems that are encountered to a great extent in the field of immobilizer systems for means of locomotion, in particular in the field of motor vehicles.

One further application area for the present invention is the field of buildings security, since the electronic communications system with its base station and with its transponder station is also suited in an advantageous manner for the realization of secure, transponder-based access systems.

Accordingly, the base station may be disposed on, in particular, an object to be secured against unauthorized use and/or unauthorized access, for example on a means of locomotion or on an access system.

The invention will be further described with reference to examples of embodiments shown in the drawings, to which, however, the invention is not restricted.

FIG. 1A shows a schematic representation of the inductive-coupling based communications principle between a base station and an associated transponder station in accordance with one embodiment example from the prior art.

FIG. 1B shows a schematic representation of a relay attack on the embodiment example from the prior art as shown in FIG. 1A.

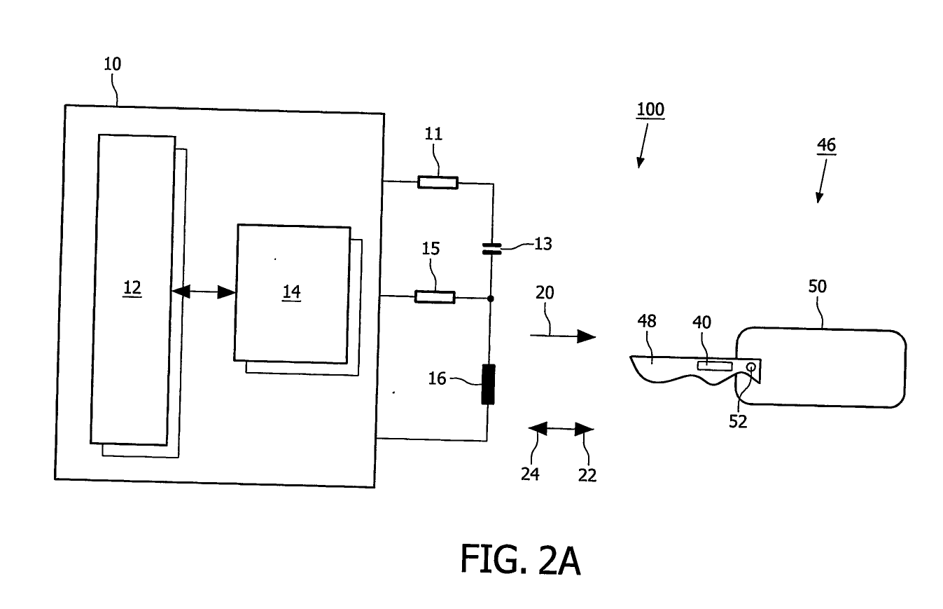

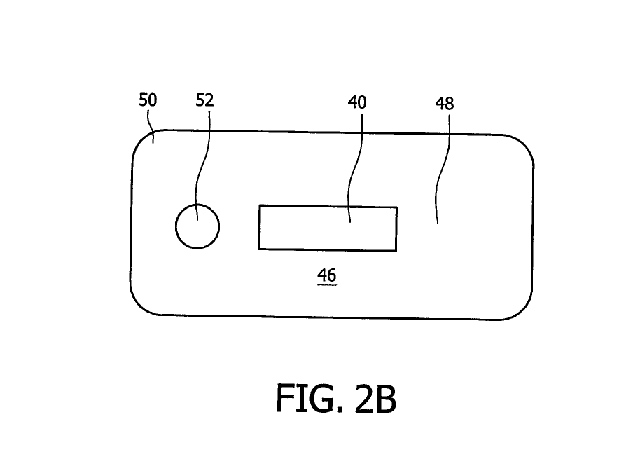

FIG. 2A shows a schematic representation of the inductive-coupling based communications principle between a base station and an associated transponder station in the active state in accordance with one embodiment example of the present invention.

FIG. 2B shows a schematic representation of the transponder station as shown in FIG. 2a, in the passive state.

Identical or similar embodiments, elements or features are provided with identical reference characters in FIGS. 1A to 2B.

As shown in FIG. 2A with reference to one embodiment example, an electronic communications system 100, equipped with inter alia a transponder system (=transponder station 40), which is in turn part of a security system in the form of an electronic immobilizer for a motor vehicle, is realized by the present invention.

The transponder station 40 itself is carried by the authorized user of the motor vehicle and, to this end, is accommodated in the web 48 of the key 46 belonging to the vehicle's ignition lock (see FIG. 2A).

Also shown in FIG. 2A is a base station 10, equipped with a microcontroller unit 12 and, connected to the microcontroller unit 12, an analog interface unit 14, in addition to two resistors 11, 15 and a capacitive unit (=capacitor 13), which is connected between the two resistors 11, 15 and is connected to an antenna unit 16, which takes the form of a coil.

On the one hand, the antenna unit 16 supplies the transponder station 40 inductively with power 20, i.e. the transponder station 40 is fed via an inductive field; on the other, in the active state (see FIG. 2A) of the transponder station 40, a communication sequence for authentication takes place between the base station 10 and the transponder station 40, to which end data signals 22, 24 are exchanged between the base station 10 and the transponder station 40; not only can the utilization and/or access entitlement for the motor vehicle be determined by means of these data signals 22, 24, but also the base station 10 can be controlled accordingly.

In detail, there exist, as signal transmission links between the base station 10 and the transponder station 40, both an up-link frame 22, which, for example, takes the form of at least one LF (Low Frequency) channel with inductive coupling and is transmitted via the signals from the base station 10 to the transponder station 40, and a down-link frame 24, which, for example, takes the form of at least one UHF (Ultra High Frequency) channel and is transmitted via the signals from the transponder station 40 to the base station 10.

Following actuation of, for example, the ignition key of the motor vehicle, the base station 10 associated functionally and spatially with the motor vehicle starts to generate a signal known as a “challenge”, which is transmitted via the up-link frame 22 to the transponder station 40. Subsequently, an electronic circuit configuration, preferably equipped with at least one microprocessor, in the transponder station 40 calculates from the challenge a signal train known as a “response” by means of a cryptographic algorithm and a secret code. This response signal is then transmitted from the transponder station 40 via the down-link frame 24 to the base station 10.

The base station 10 then compares the response using an identical crypto-algorithm and an identical secret code; if identity is established, the base station 10 causes the engine of the vehicle to start, i.e. only if the authentication recognizes the transponder station 40 as valid, generally using cryptographic methods, will the engine of the motor vehicle be started in the embodiment example described.

In order to prevent, in a reliable manner, an external attacker who, without authorization, is attempting to start the vehicle's engine, from carrying out a “relay attack” (see FIG. 1B and the related explanation above) with relatively little technical intervention, the transponder station 40 is screened from electrical, magnetic and electromagnetic fields in the passive state (see FIG. 2B) by means of a housing-shaped screening unit 50 produced from metallic materials (ferrites).

Also shown in FIG. 2A is an embodiment example of the vehicle key 46 with the transponder 40, wherein the transponder 40 is resistant to relay attacks of the type described with reference to FIG. 1B.

To this end, the key web 48, which, in the active state of the transponder station 40, is disposed outside the screening unit 50 (see FIG. 2A: transponder 40 is in the “activated” state and no longer screened), is, in the passive state of the transponder station 40, accommodated in the screening unit 50 (see FIG. 2B: transponder 40 is screened, i.e. in the “passivated” state).

In order to realize this screening, on transition of the transponder station 40 from the active state (see FIG. 2A) into the passive state (see FIG. 2B), the screening unit 50 is automatically pulled over the transponder station 40 by means of an articulation unit 52 equipped with a return spring (a so-called “rotary embodiment variant” for screening the transponder 40 in the passive state).

If, for example, the key 46 is withdrawn from the lock of the means of locomotion to be protected, the key web 48 is recessed, together with the transponder 40, in the metallic housing 50 upon this withdrawal process, since there is then a deliberate intention not to use the transponder 40.

The arrangement described with reference to FIGS. 2A and 2B can also be used, in a similar manner, to avert relay attacks in access/entry systems.

### LIST OF REFERENCE NUMBERS

100 Electronic communications system
10 Base station
11 First resistor of the base station 10
12 Microcontroller unit of the base station 10
13 Capacitive unit of the base station 10
14 Analog interface of the base station 10
15 Second resistor of the base station 10
16 Antenna unit of the base station 10
20 Power
22 Up-link frame in the form of an LF (Low Frequency) channel
22′ Up-link frame emulation in the form of an LF channel
24 Down-link frame in the form of e.g. an LF (Low Frequency) channel
24′ Down-link frame emulation in the form of e.g. an LF channel
30 Additional transmission path
32 First relay in the form of an emulator for the transponder station 40
34 Antenna unit of the first relay 32
35 Message connection between the first relay 32 and the second relay 36
36 Second relay in the form of an emulator for the base station 10
38 Antenna unit of the second relay 36
40 Transponder station
42 Circuit configuration of the transponder station 40
44 Antenna unit of the transponder station 40
46 Key
48 Web of the key 46
50 Screening unit
52 Articulation unit equipped with at least one spring device

1. An electronic communications system (100) equipped with:
at least one base station (10) with at least one antenna unit (16), in particular taking the form of a coil, which base station (10) is disposed on, in particular, an object to be secured against unauthorized use and/or unauthorized access, for example on a means of locomotion or on an access system, and
at least one transponder station (40) with at least one antenna unit (44), in particular taking the form of a coil, which transponder station (40)
can, in particular, be carried by an authorized user and/or
is designed to exchange data signals (22, 24) with the base station (10) in the active state, wherein, by means of the data signals (22, 24)
the utilization and/or access entitlement can be determined and/or
the base station (10) can be controlled accordingly,
characterized in that the transponder station (40), in particular the antenna unit (44) of the transponder station (40), is screened, in the passive state, from electrical fields and/or from magnetic fields and/or from electromagnetic fields, by means of at least one screening unit (50).

2. A communications system as claimed in claim 1, characterized in that the screening unit (50) can be disposed, automatically or manually, against and/or on and/or over the transponder station (40), in particular against and/or on and/or over the antenna unit (44) of the transponder station (40), by means of, for example, at least one rotary and/or translatory motion of the screening unit (50) relative to the transponder station (40), in particular relative to the antenna unit (44) of the transponder station (40), on transition from the active state of the transponder (40) into the passive state of the transponder station (40).

3. A communications system as claimed in claim 1, characterized in that the screening unit (50)
is formed, at least partially, from at least one metallic material and/or from at least one ferrite, and/or
takes the form of a metallic housing to accommodate the transponder station (40), in particular the antenna unit (44) of the transponder station (40).

4. A base station (10) for an electronic communications system (100) with at least one antenna unit (16), in particular taking the form of a coil, which base station (10)
is disposed, in particular, on an object to be secured against unauthorized use and/or against unauthorized access, for example on a means of locomotion or on an access system,
and is designed for the exchange of data signals (22, 24) with a transponder station (40) in its active state, wherein, by means of the data signals (22, 24)
the utilization and/or access entitlement can be determined and/or
the base station (10) can be controlled accordingly.

5. A base station as claimed in claim 4, characterized by
at least one microcontroller unit (12) and
at least one analog interface (14) connected to the microcontroller unit (12).

6. A transponder station (40) for an electronic communications system (100) with at least one antenna unit (44), in particular taking the form of a coil, which transponder station (40)
can, in particular, be carried by an authorized user and/or
is designed to exchange data signals (22, 24) with a base station (10) in the active state, wherein, by means of the data signals (22, 24)
the utilization and/or access entitlement can be determined,
which transponder station (40), in particular the antenna unit (44) of the transponder station (40), is screened, in the passive state, from electrical fields and/or from magnetic fields and/or from electromagnetic fields by means of at least one screening unit (50).

7. A transponder station as claimed in claim 6, characterized by at least one electrical or electronic circuit configuration (42), which is connected to the antenna unit (44).

8. A transponder station as claimed in claim 6, characterized in that the transponder station (40) is arranged in the web (48) of a key (46), which web (48)
in the passive state of the transponder station (40), is accommodated in the screening unit (50) and
in the active state of the transponder station (40), is disposed outside the screening unit (50).

9. A transponder station as claimed in claim 6, characterized in that, on transition of the transponder station (40) from the active state into the passive state, the screening unit (50) is automatically pulled over the transponder station (40), in particular over the antenna unit (44) of the transponder station (40), by means of at least one articulation unit (52) equipped with at least one spring device, for example when the key (46) is withdrawn from the lock of a means of locomotion.

10. A use of at least one electronic communications system (100) as claimed in claim 1, in particular of at least one transponder station (40) as claimed in claim 6, for authentication and/or for identification and/or for controlling the authorization to use, to enter, etc. any object to be secured by means of the communications system (100), such as a means of locomotion or an access system.
